(19) United States
(12) Patent Application Publication
(10) Pub. No.: US 2015/0319129 A1
(43) Pub. Date: Nov. 5, 2015

(54) Method of Providing a Location-Based Social Media and Networking Application by Executing Computer-Executable Instructions Stored On a Non-Transitory Computer-Readable Medium

(71) Applicants: Ronald M. Dismuke, Tampa, FL (US); Essie L. Dismuke, Valrico, FL (US)

(72) Inventors: Ronald M. Dismuke, Tampa, FL (US); Essie L. Dismuke, Valrico, FL (US)

(21) Appl. No.: 14/703,686

(22) Filed: May 4, 2015

Related U.S. Application Data
(60) Provisional application No. 61/987,538, filed on May 2, 2014.

(51) Int. Cl. H04L 12/58; H04W 4/02

(52) U.S. Cl. CPC H04L 51/32; H04W 4/02

(57) ABSTRACT

A location-based social media and networking application provides the ability to connect users within and across geographical locations by organizing user messages by location identifier code, such as a zip code.

The current application claims a priority to the U.S. Provisional Patent application Ser. No. 61/987,538 filed on May 2, 2014. The current application is filed on May 4, 2015, whereas May 2, 2015 and May 3, 2015 were on a weekend.

### FIELD OF THE INVENTION

The present invention relates generally to social media. More particularly, the present invention relates to location-based media interaction.

### BACKGROUND OF THE INVENTION

A social networking service (also social networking site or SNS) is a platform to build social networks or social relations among people who share interests, activities, backgrounds or real-life connections. A social network service consists of a representation of each user (often a profile), his or her social links, and a variety of additional services. Social network sites are web-based services that allow individuals to create a public profile, to create a list of users with whom to share connections, and view and cross the connections within the system. Most social network services are web-based and provide means for users to interact over the Internet, such as e-mail and instant messaging. Social network sites are varied and they incorporate new information and communication tools such as mobile connectivity, photo/video/sharing and blogging. Online community services are sometimes considered a social network service, though in a broader sense, social network service usually means an individual-centered service whereas online community services are group-centered. Social networking sites allow users to share ideas, pictures, posts, activities, events, interests with people in their network.

In recent years social media platforms have grown very rapidly and people are becoming more and more reliant on social media platforms in their daily lives and routines. It is the object of the present invention to present a social media platform that can be used by individuals or groups to network and share any form of online communication within a specific geographical area in order to stay connected and up to date within the community. The present invention is preferably known as “ZZipit.” The mission of ZZipit is to link communities for the use of online information that is geographically separated through the use of zip-codes. The objective of ZZipit is to allow individuals to share online all news worthy events in a timely manner.

### BRIEF DESCRIPTION OF THE DRAWINGS

FIG. 1 is a stepwise flow diagram describing the general process of the present invention.

FIG. 2 is a stepwise flow diagram describing steps relating to sending, receiving and displaying messages.

FIG. 3 is a stepwise flow diagram describing steps for displaying the location message sets and message detail screens.

FIG. 4 is a stepwise flow diagram describing steps for modifying the scoring value of user messages.

FIG. 5 is an example location message set as an ordered list.

FIG. 6 is an example location message set as icons on a map view.

FIG. 7 is an example user message input screen.

FIG. 8 is an example message detail screen.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

The present invention is a method of providing and executing a location-based social media and networking application. The present invention provides users with the ability to share online information in many forms with other participants within the context of a desired location, such as, but not limited to, a United States zip code, area code, global positioning system (GPS) coordinates or other types of coordinates, or another type of location identifier. The preferred embodiment of the present invention is referred to as “ZZipit,” in reference to the preferred use of U.S. zip code for location identification. The spirit of ZZipit further encompass the ideal for participants to share their consumer information that is collected and stored from the usage of any social media platforms, mobile applications or Internet devices with a corresponding zip-code identifying participants location. The meaning of the word “ZZipit” refers to when online users update a status or otherwise post a message through the means of photo images, narratives, or other media or information followed by a zip-code which the status or post is in reference to.

One object in use of the present invention is for its participants to get as many “neighbors” as possible within a zip-code area in efforts to build that community through an abundance of information obtain from such participants shared experiences. Neighbors are users who are connected either through being associated with the same location such as, but not limited to, a zip-code, or through another means of association such as a manual request to becomes friends with or follow a user.

The present invention may be used by individuals or groups to share all forms of online communication including, but not limited to, synchronous, asynchronous and hybrid communication. For example, active real-time user to user message delivery, passive message delivery through a first user sending a message which a second user has an option to view, or a combination of both, respectively, or other forms of communication. In the preferred embodiment of the present invention, all forms of online communications and below examples shall have a specified USPS zip-code or a foreign nation postage number preceding it, or another relevant type of location identifier code as previously disclosed. Non-limiting examples of relevant online communications include: narratives, text, essays, chats, blogs, instant messaging, images, social media, cloud documents, resumes, videos, and pictures.

The stored information from the shared forms of communication utilized with the present invention will be categorized by topic groups in the preferred embodiment, allowing the user to find their search topics with ease. ZZipit participant can tap into any Foreign or domestic designated zip code to view the latest narratives of events or link onto friends or other users in the ZZipit platform communicated zip-code as neighbors and follow such events. The present invention provides the ability to build up communities through individuals' continued sharing of “narratives,” or user messages associated with a zip code. The process is unique, compiling the everyday activities of individuals' social activities geographically throughout vast communities. The ZZipit platform uses the information from its participant's narratives for the purpose bringing communities together through difference sources of information for awareness and upward mobility. All shared information is retained and stored within its zip-code origin, allowing the general public the access to a wealth of information for their consumer needs and social entertainment. “ZZips” or posts shared on the ZZipit platform—photo, narrative or other communication, may also be shared on other social media platforms or outlets. In this case, ZZips that are shared on other social media outlets will have a watermark and/or be stamped with the associated zip-code.

The preferred embodiment of the present invention is as a digital, executable application on a computing device. Any computing device with which the present invention may be facilitated may be utilized, such as, but not limited to, a personal computer, a mobile device such as a smartphone or tablet, or another device. The present invention may be built using any applicable programming language or combination of programming languages, such as, but not limited to, Django, Python, HTML, XML, C, C++, Java, or another programming language.

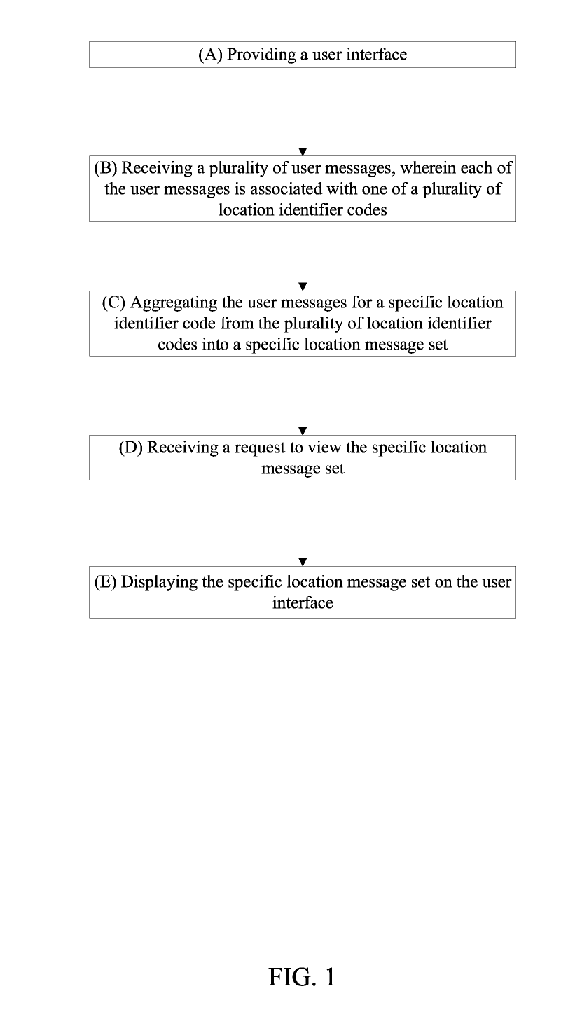

In the general process of the present invention as shown in FIG. 1, a user interface is provided. The user interface is part of the computing device of the present invention and allows a user to interface with the application of the present invention. The user interface should comprise a digital display and an input means. In the preferred embodiment as a smartphone application, the user interface is the touchscreen of the smartphone.

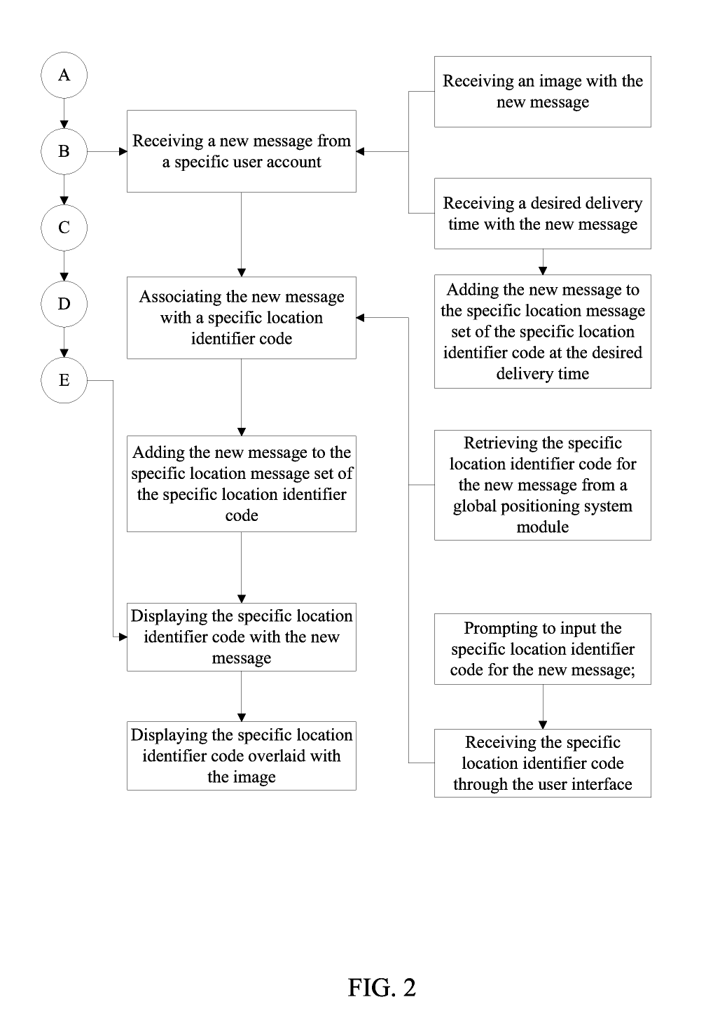

A plurality of user messages are received, wherein each of the user messages is associated with one of a plurality of location identifier codes. As previously disclosed, a location identifier code is preferably a U.S. zip code, but may take other embodiments, such as but not limited to an area code or another location identifier. Each user message may include, but is not limited to, text, an image, and the location identifier code associated with the user message. In the preferred embodiment, each user message is required to be associated with a location identifier code, while including an image or a text description is optional. However, a user message should not lack both an image and a text description. If a user message lacks both an image and a text description, an error message appears. FIG. 2 shows a plurality of steps and permutations of receiving and displaying a message.

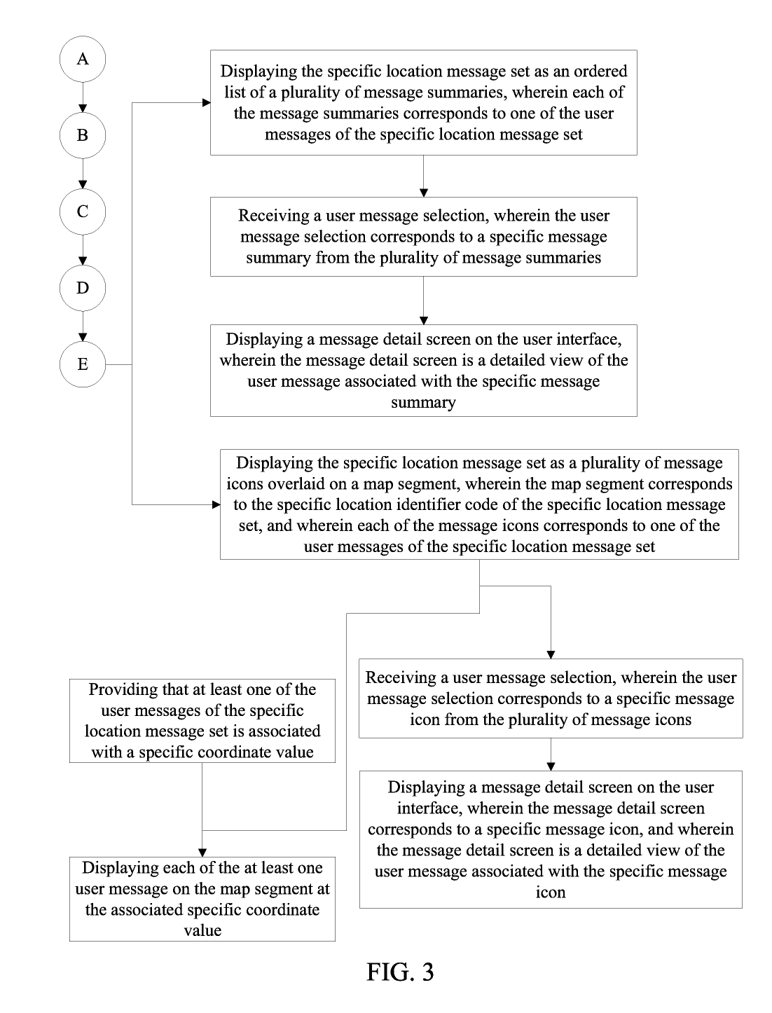

Referring to FIG. 3, the user messages for a specific location identifier code from the plurality of location identifier codes are aggregated into a specific location message set. This is done for each location identifier code. A request may then be received from a user to view the specific location message set, and subsequently the specific location message set is displayed on the user interface of the user making the request to view the specific location message set of the specific location identifier code.

An individual user may utilize the present invention to share a text description, an image, or other media with the rest of the community utilizing the present invention. To this end, a user creates a new message which is received from a specific user account associated with the user. The new message is associated with a specific location identifier code, and then the new message is added to the specific location message set of the specific location identifier code. The new message is then ready to view by other users viewing the specific location message set of the specific location identifier code.

In the preferred embodiment of the present invention, the specific location identifier code may be designated in one of two ways as described in FIG. 2. Firstly, the specific location identifier code may be retrieved for the new message from a global positioning system module of the computing device. In this case, the computing device is a smartphone, tablet, personal computer or other computing device with GPS capabilities and with the GPS signal activated. Retrieving the coordinates of the computing device's current location is a well-known process and is achieved through any relevant means. After the current coordinates of the computing device are retrieved, the coordinates are processed in order to determine the zip code (or other location identifier code as applicable) to which the coordinates belong in order to designate the specific location identifier code of the new message. The other means of designating the specific location identifier code is to prompt the user to input the specific location identifier code, which the user subsequently inputs through the user interface and is received by the system of the present invention. This option may be utilized when the user wishes to post a new message with a location identifier code different from the user's current location, or in the absence of GPS capabilities. For example, if a user is currently in Los Angeles whereas the user's home city is Miami, the user may manually input the location identifier code for Miami in order to interact with the specific location message set of Miami. The specific location identifier code should be displayed with the new message.

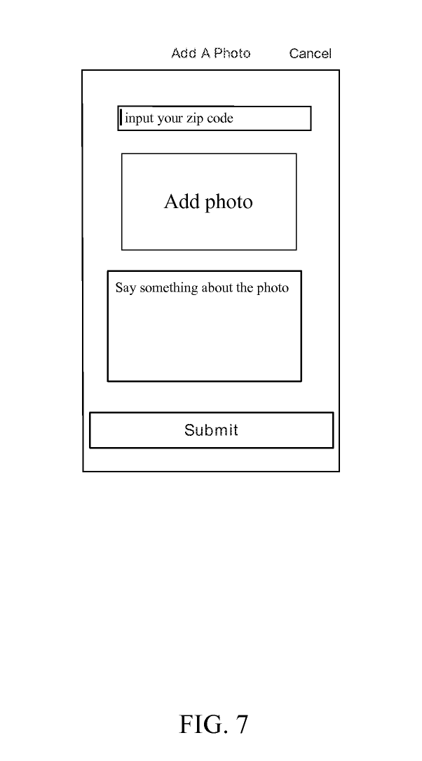

In many instances, a user may wish to upload an image with the new message. An example screen on the user interface for adding a photo is shown in FIG. 7. For example, a user may wish to express to the community appreciation or awareness of a certain restaurant, dish, concert, event or other goings-on. The user may attach the image from an on-device library of images, or the user may take a new image with an on-device camera. The user may be provided with the option to edit the image through various means. Once the user submits the new message, the new message is received by the system and added to the specific location message set for other users to view. In one embodiment, the specific location identifier code is displayed overlaid with the image. In another embodiment, the specific location identifier code is not displayed overlaid with the image, and is displayed adjacent to the image instead.

One desired feature in the preferred embodiment of the present invention is a share delay posting ability as shown in FIG. 2. A desired delivery time is received with the new message, which the user specifies. The new message is then added to the specific location message set of the specific location identifier code at the desired delivery time. In this case, the new message may be sent to and stored on a server before delivery, or the new message may be placed in a queue on the computing device, or any other means for delayed message delivery may be utilized to achieve this feature. This feature allows users to update a status that does not send immediately, but sends automatically at the future time specified.

While any given user is not required to post new messages, any given user utilizing the present invention will inevitably view one of more messages posted due to the nature and purpose of the application. Users are provided with a number of means of viewing user messages associated with various location identifier codes. Firstly, in the preferred embodiment the user is shown a specific location message set by default when the user signs up for and utilizes the social networking application of the present invention. This specific location message set may be defined in any appropriate manner, particularly defaulting to current coordinates of the user's device. The user may also request to view the message set for any given existing location identifier code, either by selection a location identifier code from a list, or by manually inputting the location identifier code.

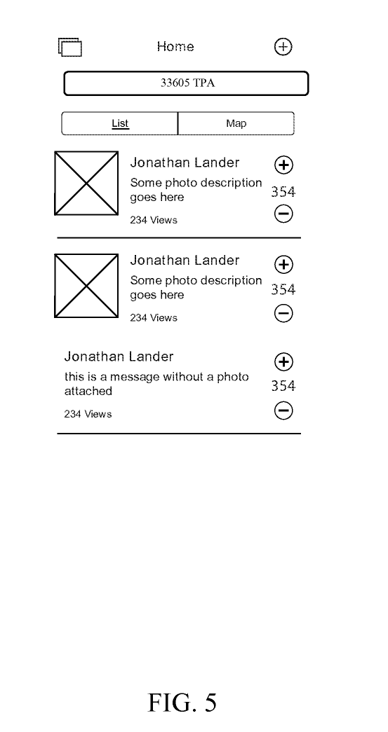

Referring to FIG. 3, in the preferred embodiment, the specific location message set may be displayed to the user in one of two ways, which the user may switch back and forth between at will. Firstly, the specific location message set may be displayed as an ordered list of a plurality of message summaries as shown in FIG. 5, wherein each of the message summaries corresponds to one of the user messages of the specific location message set. In this embodiment, the plurality of message summaries are ordered by time posted, with the most recently posted user message being displayed at the top of the list. It is contemplated however that other ordering schemes may be utilized as desired, such as, but not limited to, ordering the message summaries by relative score, size, or by another or multiple characteristics. In the preferred embodiment, for any given location identifier code, only 100 user messages are stored at any given moment. If a location identifier code has 100 messages currently posted, and another message is received, the new message becomes the first message, the original 100^{th} message is removed, the original 99^{th} message becomes the new 100^{th} message, and so on, wherein the first message refers to the most recent message.

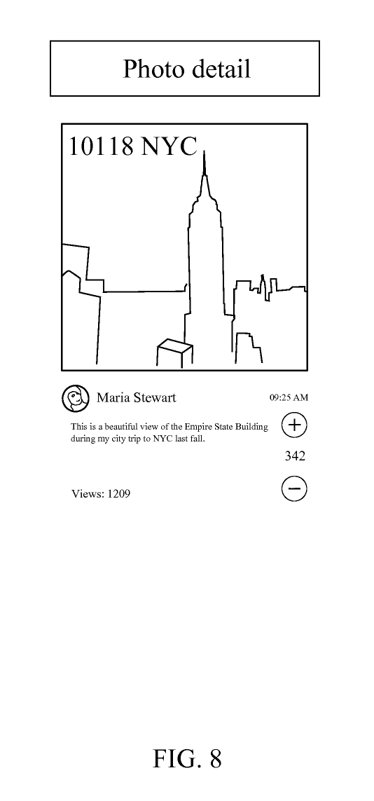

The message summaries should contain a thumbnail image of the image received with the message, if an image exists with the message, and a short description of the message or the first few words of the message. Should a user wish to view more detail about a particular message, the user makes a selection. A user message selection is received through the user interface, wherein the user message selection corresponds to a specific message summary from the plurality of message summaries on the list. Subsequently, a message detail screen is displayed on the user interface, wherein the message detail screen is a detailed view of the user message associated with the specific message summary. The message detail screen presents the entire message to the user, including the location identifier code, the entirety of any accompanying description and any accompanying image, video or other media. An example message detail screen is shown in FIG. 8.

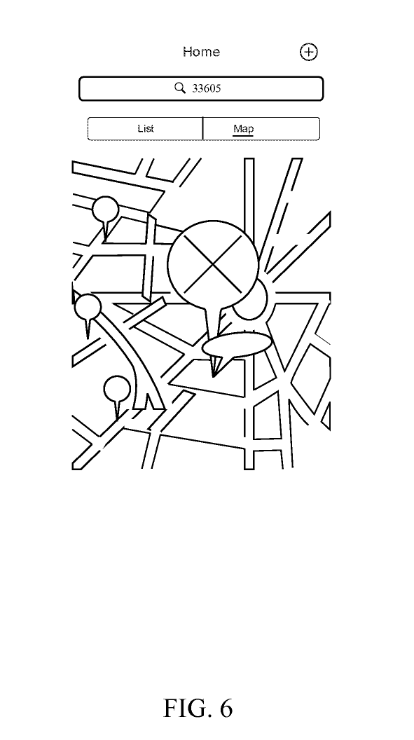

The second manner in which the specific location message set may be displayed is as a plurality of message icons overlaid on a map segment, as shown in FIG. 6. The map segment corresponds to the specific location identifier code of the specific location message set, and each of the message icons corresponds to one of the user messages of the specific location message set. Ideally, the message icons should be displayed on the map segment with more accuracy than a location identifier code, which can indicate a fairly large area. To this end, at least one of the user messages of the specific location message set is associated with a specific coordinate value, which was retrieved from the GPS module of the device the message was posted from. Each user message associated with a coordinate values is displayed on the map segment at the associated specific coordinate value. To view a message, a user message selection is received from a user, wherein the user message selection corresponds to a specific message icon from the plurality of message icons on the map segment. The message detail screen is then displayed as described previously, wherein in this case the message detail screen corresponds to a specific message icon, and wherein the message detail screen is a detailed view of the user message associated with the specific message icon.

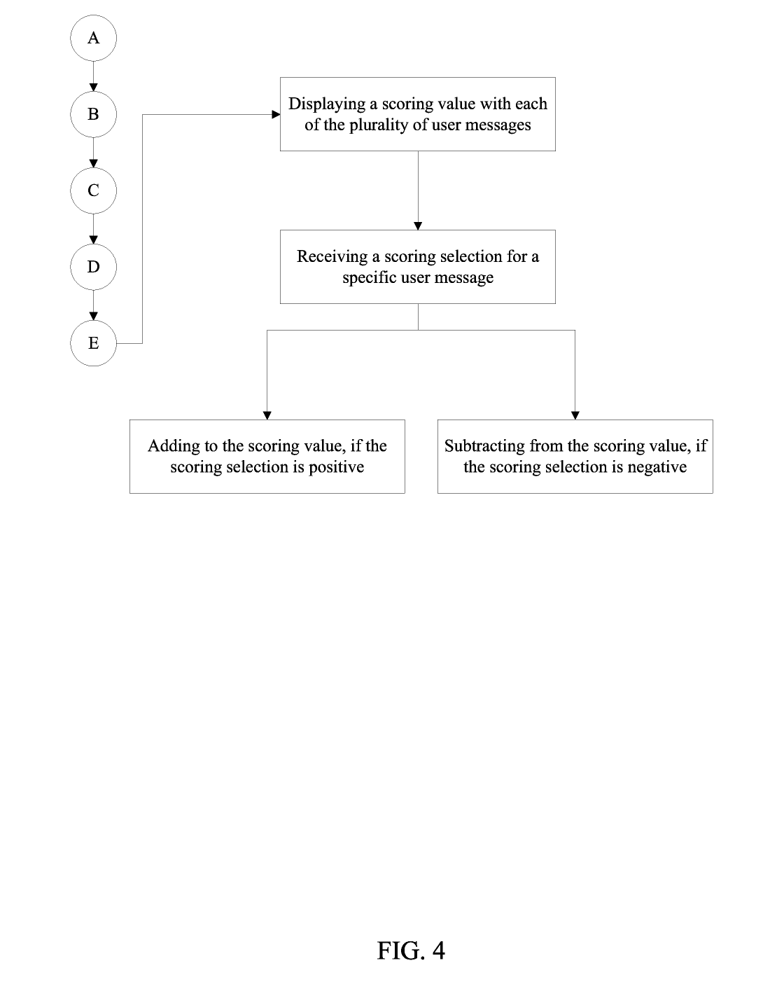

Another feature incorporated in the preferred embodiment of the present invention is a scoring or ranking system as shown in FIGS. 4, 5 and 8. Each user message can be rated by other users in order to provide an indication of popularity or quality. To this end, a scoring value is displayed with each of the plurality of user messages. For a specific user message, when a scoring selection is received, the scoring value is added to if the scoring selection is positive, and subtracted from if the scoring selection is negative. In one embodiment, the scoring value is a numerical value which represents the net sum of positive and negative scoring selections for the message. In another embodiment, the scoring value is based on a rating system where users may rate messages on a scale, such as, but not limited to, 1 to 5.

Other features comprised in the preferred embodiment of the present invention, include, but are not limited to the following. Users should be provided with the capability to customize and manage favorite location identifier codes. For example, a user in California on a business trip whose home is in Miami may wish to save their home's location identifier code as a favorite for easy access. User may also block location identifier codes they do not wish to view. Users are able to search not only location identifier codes, but also topics, such as, but not limited to, hotels, restaurants, retail, real estate, newsworthy events, sports, entertainment, social events, political polling, religion, blog posting, employment and travel. User may also search by city, state or county name, or other geographical identifiers, in addition to location identifier codes such as zip codes and area codes. In some embodiments monetary transaction features may be included, such as, but not limited to, user to user payments, payments to the administrator of the system, for removing ads or unlocking new features for example, or other types of payments. Third-party advertising may also be permitted. Local companies may wish to advertise their brand in their geographical location using the present invention. Additionally, the ZZipit platform of the present invention may be used to organize geographical polling and vote counting through the use of zip-codes.

Although the invention has been explained in relation to its preferred embodiment, it is to be understood that many other possible modifications and variations can be made without departing from the spirit and scope of the invention as hereinafter claimed.

What is claimed is:

1. A method of providing a location-based social media and networking application by executing computer-executable instructions stored on a non-transitory computer-readable medium comprises the steps of:
providing a user interface;
receiving a plurality of user messages, wherein each of the user messages is associated with one of a plurality of location identifier codes;
aggregating the user messages for a specific location identifier code from the plurality of location identifier codes into a specific location message set;
receiving a request to view the specific location message set;
displaying the specific location message set on the user interface.

2. A method of providing a location-based social media and networking application by executing computer-executable instructions stored on a non-transitory computer-readable medium as claimed in claim 1 comprises the steps of:
receiving a new message from a specific user account;
associating the new message with a specific location identifier code;
adding the new message to the specific location message set of the specific location identifier code.

3. A method of providing a location-based social media and networking application by executing computer-executable instructions stored on a non-transitory computer-readable medium as claimed in claim 2 comprises the steps of:
retrieving the specific location identifier code for the new message from a global positioning system module.

4. A method of providing a location-based social media and networking application by executing computer-executable instructions stored on a non-transitory computer-readable medium as claimed in claim 2 comprises the steps of:
prompting to input the specific location identifier code for the new message;
receiving the specific location identifier code through the user interface.

5. A method of providing a location-based social media and networking application by executing computer-executable instructions stored on a non-transitory computer-readable medium as claimed in claim 2 comprises the steps of:
displaying the specific location identifier code with the new message.

6. A method of providing a location-based social media and networking application by executing computer-executable instructions stored on a non-transitory computer-readable medium as claimed in claim 2 comprises the steps of:
receiving an image with the new message.

7. A method of providing a location-based social media and networking application by executing computer-executable instructions stored on a non-transitory computer-readable medium as claimed in claim 6 comprises the steps of:
displaying the specific location identifier code overlaid with the image.

8. A method of providing a location-based social media and networking application by executing computer-executable instructions stored on a non-transitory computer-readable medium as claimed in claim 2 comprises the steps of:
receiving a desired delivery time with the new message;
adding the new message to the specific location message set of the specific location identifier code at the desired delivery time.

9. A method of providing a location-based social media and networking application by executing computer-executable instructions stored on a non-transitory computer-readable medium as claimed in claim 1 comprises the steps of:
displaying the specific location message set as an ordered list of a plurality of message summaries, wherein each of the message summaries corresponds to one of the user messages of the specific location message set.

10. A method of providing a location-based social media and networking application by executing computer-executable instructions stored on a non-transitory computer-readable medium as claimed in claim 9 comprises the steps of:
receiving a user message selection, wherein the user message selection corresponds to a specific message summary from the plurality of message summaries;
displaying a message detail screen on the user interface, wherein the message detail screen is a detailed view of the user message associated with the specific message summary.

11. A method of providing a location-based social media and networking application by executing computer-executable instructions stored on a non-transitory computer-readable medium as claimed in claim 1 comprises the steps of:
displaying the specific location message set as a plurality of message icons overlaid on a map segment, wherein the map segment corresponds to the specific location identifier code of the specific location message set, and wherein each of the message icons corresponds to one of the user messages of the specific location message set.

12. A method of providing a location-based social media and networking application by executing computer-executable instructions stored on a non-transitory computer-readable medium as claimed in claim 11 comprises the steps of:
providing that at least one of the user messages of the specific location message set is associated with a specific coordinate value;
displaying each of the at least one user message on the map segment at the associated specific coordinate value.

13. A method of providing a location-based social media and networking application by executing computer-executable instructions stored on a non-transitory computer-readable medium as claimed in claim 11 comprises the steps of:
receiving a user message selection, wherein the user message selection corresponds to a specific message icon from the plurality of message icons;
displaying a message detail screen on the user interface, wherein the message detail screen corresponds to a specific message icon, and wherein the message detail screen is a detailed view of the user message associated with the specific message icon.

14. A method of providing a location-based social media and networking application by executing computer-executable instructions stored on a non-transitory computer-readable medium as claimed in claim 1 comprises the steps of:
displaying a scoring value with each of the plurality of user messages.

15. A method of providing a location-based social media and networking application by executing computer-executable instructions stored on a non-transitory computer-readable medium as claimed in claim 14 comprises the steps of:
receiving a scoring selection for a specific user message.

16. A method of providing a location-based social media and networking application by executing computer-executable instructions stored on a non-transitory computer-readable medium as claimed in claim 15 comprises the steps of:
adding to the scoring value, if the scoring selection is positive.

17. A method of providing a location-based social media and networking application by executing computer-executable instructions stored on a non-transitory computer-readable medium as claimed in claim 15 comprises the steps of:
subtracting from the scoring value, if the scoring selection is negative.
